(19) United States
(12) Patent Application Publication
(10) Pub. No.: US 2023/0133010 A1
(43) Pub. Date: May 4, 2023

(54) PAIR OF BLADES AND WORKING MACHINE COMPRISING THE SAME

(71) Applicant: MAKITA CORPORATION, Anjo-shi (JP)

(72) Inventors: Tomoyuki KUTSUNA, Anjo-shi (JP); Mikihiro KITAHARA, Anjo-shi (JP)

(73) Assignee: MAKITA CORPORATION, Anjo-shi (JP)

(21) Appl. No.: 17/978,394

(22) Filed: Nov. 1, 2022

(30) Foreign Application Priority Data
Nov. 2, 2021 (JP) 2021-179363

(51) Int. Cl. A01G 3/053

(52) U.S. Cl. CPC A01G 3/053

(57) ABSTRACT

A working machine may include a pair of blades and a prime mover configured to reciprocate the pair of blades relative to each other. Each of the pair of blades may include a plurality of edge portions disposed along a reciprocating direction. Each of the plurality of edge portions of one of the pair of blades may include a slide surface configured to slide with respect to the plurality of edge portions of the other of the pair of blades as the pair of blades reciprocates relative to each other, a first edge surface connected to the slide surface and disposed at a first angle with respect to the slide surface, and a second edge surface connected to the first edge surface and disposed at a second angle with respect to the slide surface. The first angle may be greater than the second angle.

### CROSS-REFERENCE TO RELATED APPLICATION

This application claims priority to Japanese Patent Application No. 2021-179363, filed on Nov. 2, 2021, the entire contents of which are incorporated herein by reference.

### TECHNICAL FIELD

The technique disclosed herein is related to a pair of blades and a working machine comprising the same.

### BACKGROUND

Japanese Patent Application Publication No. 2010-98972 describes a working machine including a pair of blades and a prime mover that reciprocates the pair of blades relative to each other. Each of the pair of blades includes a plurality of edge portions disposed along a reciprocating direction. Each of the plurality of edge portions of one of the pair of blades includes: a slide surface which slides with respect to the plurality of edge portions of the other of the pair of blades as the pair of blades reciprocates relative to each other; and an edge surface connected to the slide surface via a connecting line and disposed at a first angle with respect to the slide surface. The connecting line is inclined with respect to the reciprocating direction.

### SUMMARY

In a working machine as described in Japanese Patent Publication Application No. 2010-98972, which cuts an object to be cut such as grass and plants by reciprocating a pair of blades including a plurality of edge portions relative to each other, when the object is cut, the edge portions of the pair of blades cut into the object using their cutting edges and tear and open the object in a direction orthogonal to a cutting direction using their portions that are separated away from the cutting edges. Therefore, when the object is cut, very high load is applied to the cutting edges of the edge portions of the pair of blades. On the other hand, sharpness of the edge portions of the pair of blades depends on resistance received in the cutting direction when the edge portions tear and open the object using the portions separated away from the cutting edges. In addition to the sharpness, durability is also required for such edge portions of the pair of blades as described above, especially when they are designed to operate under a high voltage and high torque. The working machine of Japanese Patent Application Publication No. 2010-98972 only has one edge surface disposed at an angle with respect to the slide surface at each of the edge portions of the pair of blades. Consequently, when an angle between the slide surface and the edge surface is decreased, the sharpness is increased due to decrease in the resistance received in the cutting direction, however, the durability against the load applied upon cutting is adversely decreased. On the other hand, when the angle between the slide surface and the edge surface is increased, the durability against the load applied upon cutting is increased, however, the sharpness is adversely decreased due to increase in the resistance received in the cutting direction. In other words, the sharpness and the durability cannot be achieved simultaneously by the edge portions of the pair of blades of the working machine of Japanese Patent Application Publication No. 2010-98972. The present disclosure provides a technique capable of achieving both sharpness and durability in edge portions of a pair of blades included in a working machine.

A working machine disclosed herein may comprise: a pair of blades; and a prime mover configured to reciprocate the pair of blades relative to each other. Each of the pair of blades may comprise a plurality of edge portions disposed along a reciprocating direction. Each of the plurality of edge portions of one of the pair of blades may comprise: a slide surface configured to slide with respect to the plurality of edge portions of the other of the pair of blades as the pair of blades reciprocates relative to each other; a first edge surface connected to the slide surface via a first connecting line and disposed at a first angle with respect to the slide surface, the first connecting line being inclined with respect to the reciprocating direction; and a second edge surface connected to the first edge surface via a second connecting line and disposed at a second angle with respect to the slide surface, the second connecting line being inclined with respect to the reciprocating direction. The first angle may be greater than the second angle.

A pair of blades disclosed herein may be configured to be attached to a working machine comprising a prime mover and reciprocated relative to each other by the prime mover. Each of the pair of blades may comprise a plurality of edge portions disposed along a reciprocating direction. Each of the plurality of edge portions of one of the pair of blades may comprise: a slide surface configured to slide with respect to the plurality of edge portions of the other of the pair of blades as the pair of blades reciprocates relative to each other; a first edge surface connected to the slide surface via a first connecting line and disposed at a first angle with respect to the slide surface, the first connecting line being inclined with respect to the reciprocating direction; and a second edge surface connected to the first edge surface via a second connecting line and disposed at a second angle with respect to the slide surface, the second connecting line being inclined with respect to the reciprocating direction. The first angle may be greater than the second angle.

According to the above configuration, each of the edge portions of the pair of blades has two edge surfaces. The first edge surface positioned at the cutting edge of each of the edge portions of the pair of blades is disposed at the first angle with respect to the slide surface, and the second edge surface positioned away from the cutting edge is disposed at the second angle, which is smaller than the first angle, with respect to the slide surface. Therefore, sharpness is increased by decreasing resistance received in a cutting direction when the edge portions tear and open the object to be cut, and durability against load applied upon cutting is also increased. In other words, according to the above configuration, both the sharpness and the durability can be achieved in the edge portions of the pair of blades.

### BRIEF DESCRIPTION OF DRAWINGS

FIG. 1 illustrates a perspective view of a hedge trimmer 100 of an embodiment viewed from the front right upper side.

FIG. 2 illustrates a side cross-sectional of an internal structure of the hedge trimmer 100 of the embodiment viewed from the right side.

FIG. 3 illustrates a perspective view of a pair of blades 12 included in the hedge trimmer 100 of the embodiment viewed from the front right lower side.

FIG. 4 illustrates the pair of blades 12 included in the hedge trimmer 100 of the embodiment viewed from above.

FIG. 5 illustrates an enlarged view of an edge portion 120 of the pair of blades 12 included in the hedge trimmer 100 of the embodiment viewed from above.

FIG. 6 illustrates a cross-sectional view of the edge portion 120 of the pair of blades 12 included in the hedge trimmer 100 of the embodiment, taken along a D-D cross section of FIG. 5.

FIG. 7 illustrates a cross-sectional view of the edge portion 120 of the pair of blades 12 included in the hedge trimmer 100 of the embodiment, taken along a E-E cross section of FIG. 5.

FIG. 8 illustrates a cross-sectional view of the edge portion 120 of the pair of blades 12 included in the hedge trimmer 100 of the embodiment, taken along a F-F cross section of FIG. 5.

FIG. 9A illustrates how a lower blade 12c reciprocates relative to the upper blade 12b in the hedge trimmer 100 of the embodiment when the pair of blades 12 is actuated.

FIG. 9B illustrates how the lower blade 12c reciprocates relative to the upper blade 12b in the hedge trimmer 100 of the embodiment when the pair of blades 12 is actuated.

FIG. 9C illustrates how the lower blade 12c reciprocates relative to the upper blade 12b in the hedge trimmer 100 of the embodiment when the pair of blades 12 is actuated.

FIG. 9D illustrates how the lower blade 12c reciprocates relative to the upper blade 12b in the hedge trimmer 100 of the embodiment when the pair of blades 12 is actuated.

FIG. 10A illustrates a cross-sectional schematic diagram of cutting operation of edge portions 120b, 120c of the pair of blades 12 in the state of FIG. 9A in the hedge trimmer 100 of the embodiment viewed from the left side.

FIG. 10B illustrates a cross-sectional schematic diagram of the cutting operation of the edge portions 120b, 120c of the pair of blades 12 in the state of FIG. 9B in the hedge trimmer 100 of the embodiment viewed from the left side.

FIG. 10C illustrates a cross-sectional schematic diagram of the cutting operation of the edge portions 120b, 120c of the pair of blades 12 in the state of FIG. 9C in the hedge trimmer 100 of the embodiment viewed from the left side.

FIG. 10D illustrates a cross-sectional schematic diagram of the cutting operation of the edge portions 120b, 120c of the pair of blades 12 in the state of FIG. 9D in the hedge trimmer 100 of the embodiment viewed from the left side.

FIG. 11 illustrates a schematic view of an edge portion 120 of a pair of blades 12 included in a hedge trimmer 100 of a variant viewed from the left side.

### DETAILED DESCRIPTION

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved working machines and pairs of blades as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, a working machine may comprise: a pair of blades; and a prime mover configured to reciprocate the pair of blades relative to each other. Each of the pair of blades may comprise a plurality of edge portions disposed along a reciprocating direction. Each of the plurality of edge portions of one of the pair of blades may comprise: a slide surface configured to slide with respect to the plurality of edge portions of the other of the pair of blades as the pair of blades reciprocates relative to each other; a first edge surface connected to the slide surface via a first connecting line and disposed at a first angle with respect to the slide surface, the first connecting line being inclined with respect to the reciprocating direction; and a second edge surface connected to the first edge surface via a second connecting line and disposed at a second angle with respect to the slide surface, the second connecting line being inclined with respect to the reciprocating direction. The first angle may be greater than the second angle.

In one or more embodiments, a pair of blades may be configured to be attached to a working machine comprising a prime mover and reciprocated relative to each other by the prime mover. Each of the pair of blades may comprise a plurality of edge portions disposed along a reciprocating direction. Each of the plurality of edge portions of one of the pair of blades may comprise: a slide surface configured to slide with respect to the plurality of edge portions of the other of the pair of blades as the pair of blades reciprocates relative to each other; a first edge surface connected to the slide surface via a first connecting line and disposed at a first angle with respect to the slide surface, the first connecting line being inclined with respect to the reciprocating direction; and a second edge surface connected to the first edge surface via a second connecting line and disposed at a second angle with respect to the slide surface, the second connecting line inclined with respect to the reciprocating direction. The first angle may be greater than the second angle.

According to the above configuration, each of the edge portions of the pair of blades has two edge surfaces. The first edge surface positioned at the cutting edge of each of the edge portions of the pair of blades is disposed at the first angle with respect to the slide surface, and the second edge surface positioned away from the cutting edge is disposed at the second angle, which is smaller than the first angle, with respect to the slide surface. Therefore, sharpness is increased by reducing resistance received in the cutting direction when the edge portions tear and open an object to be cut, and durability against load applied upon cutting is also increased. In other words, according to the above configuration, both sharpness and durability can be achieved in the edge portions 120 of the pair of blades.

In one or more embodiments, the first edge surface may have a first width in a direction orthogonal to the first connecting line, as viewed in a direction orthogonal to the slide surface. The second edge surface may have a second width in a direction orthogonal to the second connecting line, as viewed in the direction orthogonal to the slide surface. A ratio of the first width to the second width may be 1:4.

If the ratio of the first width of the first edge surface cutting into an object to the second width of the second edge surface tearing and opening the object is too small, the sharpness upon cutting is adversely decreased. Contrary to this, if the ratio of the first width of the first edge surface to the second width of the second edge surface is too large, the durability against the load applied upon cutting is adversely decreased. According to the above configuration, both the sharpness and durability can more suitably be achieved in each of the edge portions of the pair of blades.

In one or more embodiments, the first width may be within a range from 0.28 mm to 0.8 mm.

When the first width of the first edge surface is too small, it is difficult to achieve an effect of improving the durability. On the other hand, when the first width of the first edge surface is too large, this may cause a substantial decrease in the sharpness. According to the above configuration, in the edge portions of the pair of blades, the effect of improving the durability can sufficiently be obtained without causing a substantial decrease in the sharpness.

In one or more embodiments, the second width may be within a range from 1.12 mm to 3.2 mm.

When the second width of the second edge surface is too small, it is difficult to achieve an effect of improving sharpness. On the other hand, when the second width of the second edge surface is too large, this may cause a substantial decrease in durability. According to the above configuration, in the edge portions of the pair of blades, the effect of improving the sharpness can sufficiently be obtained without causing a substantial decrease in the durability.

In one or more embodiments, a ratio of the first angle to the second angle may be 3:2.

When the ratio of the first angle between the first edge surface and the slide surface to the second angle between the second edge surface and the slide surface is too small, sharpness upon cutting is adversely decreased. On the other hand, when the ratio of the first angle with respect to the second angle is too large, durability against the load applied upon cutting is adversely decreased. According to the above configuration, both the sharpness and durability can more suitably be achieved in the edge portions of the pair of blades.

In one or more embodiments, the first angle may be within a range from 45 degrees to 70 degrees.

When the first angle is too small, it is difficult to achieve effect of improving durability. On the other hand, when the first angle is too large, this may cause a substantial decrease in sharpness. According to the above configuration, in the edge portions of the pair of blades, the effect of improving the durability can sufficiently be obtained without causing a substantial decrease in the sharpness.

In one or more embodiments, the second angle may be within a range from 20 degrees to 45 degrees.

When the second angle is too small, this may cause a substantial decrease in the durability. On the other hand, when the second angle is too large, it is difficult to achieve an effect of improving the sharpness. According to the above configuration, in the edge portions of the pair of blades, the effect of improving the sharpness can sufficiently be obtained without causing a substantial decrease in the durability.

In one or more embodiments, the first edge surface and the second edge surface may be formed by die forging.

When the first edge surface and the second edge surface are formed on each of the edge portions, it is contemplated to perform polishing. In that case, however, the polishing needs to be separately performed on each of the plurality of edge portions, which makes mass production of the pair of blades difficult. According to the above configuration, the first edge surface and the second edge surface can be formed in one processing, thus the mass production of the pair of blades is facilitated.

### Embodiment

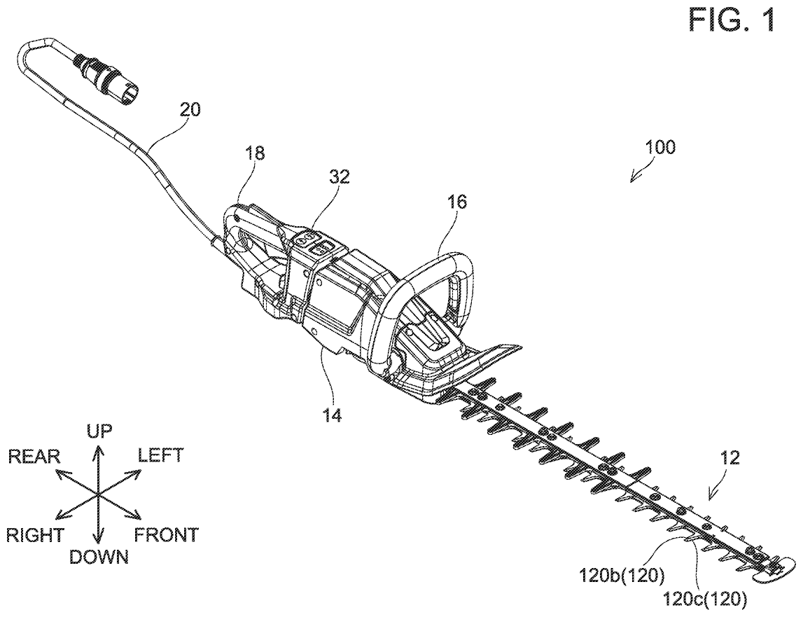

With reference to drawings, a hedge trimmer 100 will be described below as an example of a working machine comprising a pair of blades 12. The hedge trimmer 100 is a gardening tool used mainly in trimming hedges and plants. As illustrated in FIG. 1, the hedge trimmer 100 includes the pair of blades 12, a housing 14 supporting the pair of blades 12, a front handle 16 and a rear handle 18 which a user can grip, and a power cable 20 for supplying external power.

The pair of blades 12 linearly extends forward from the housing 14 and includes a plurality of edge portions 120 disposed along the longitudinal direction. The pair of blades 12 is configured to trim hedges and plants using the plurality of edge portions 120 by reciprocating relative to each other in the longitudinal direction. In the hedge trimmer 100 of the present embodiment, each of the pair of blades 12 is configured to reciprocate relative to the housing 14.

Here, in the present embodiment, the longitudinal direction of the pair of blades 12 is defined as a front-rear direction, a direction extending from the housing 14 to the pair of blades 12 is defined as a frontward direction, and a direction extending from the pair of blades 12 to the housing 14 is defined as a rearward direction. Further, a direction orthogonal to the front-rear direction and parallel to the plane where the plurality of edge portions 120 of the pair of blades 12 is positioned is defined as a left-right direction. A direction orthogonal to the front-rear direction and the left-right direction is defined as an up-down direction.

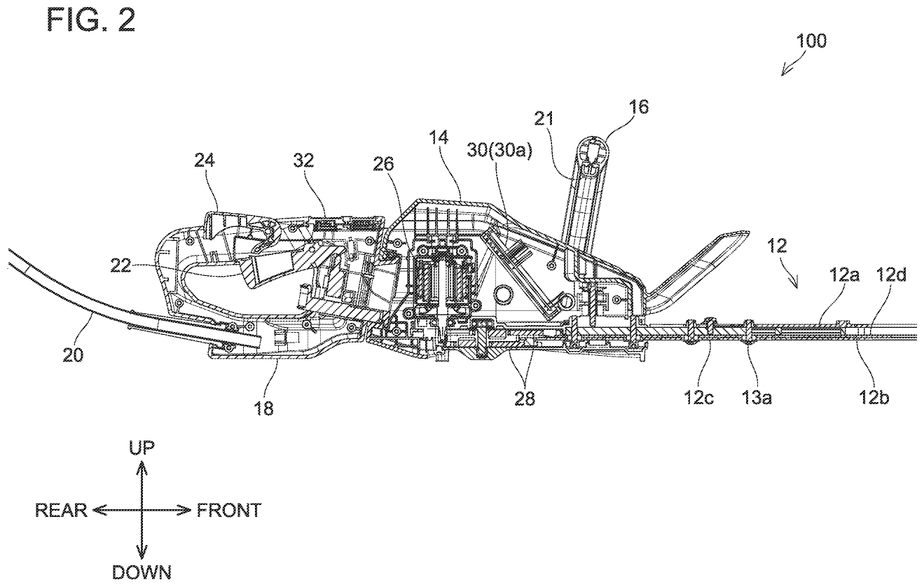

As illustrated in FIG. 2, the front handle 16 and the rear handle 18 are attached to the housing 14. The front handle 16 is positioned on the front upper side of the housing 14. The rear handle 18 is positioned on the rear side of the housing 14. The hedge trimmer 100 is a hand-held electric tool and a user usually operates the hedge trimmer 100 by gripping the front handle 16 with his/her one hand and gripping the rear handle 18 with the other hand. The front handle 16 extends along a plane angled relative to the front-rear direction. The rear handle 18 extends along the plane parallel to the front-rear direction and the up-down direction (i.e., the plane orthogonal to the left-right direction).

A first drive switch 21 is disposed on the front handle 16, and a second drive switch 22 is disposed on the rear handle 18. A lock switch 24 is disposed on the rear handle 18. The hedge trimmer 100 is configured to actuate the pair of blades 12 only when the first drive switch 21 and the second drive switch 22 are concurrently operated. The second drive switch 22 is usually mechanically locked by the lock switch 24, and its operation is permitted only when the lock switch 24 is operated. The first drive switch 21, the second drive switch 22 and the lock switch 24 are operated by the user gripping the front handle 16 and the rear handle 18. Therefore, the hedge trimmer 100 is configured such that actuation of the pair of blades 12 is prohibited unless the user grips both the front handle 16 and the rear handle 18.

The hedge trimmer 100 further includes a motor 26 as an example of a prime mover. The motor 26 is housed in the housing 14 and actuates the pair of blades 12. With regard to this point, the motor 26 is connected to the pair of blades 12 via crank cams 28 and is configured to reciprocate each of the pair of blades 12 relative to the housing 14. The motor 26 of the present embodiment is a brushless motor. The rotation axis of the motor 26 extends orthogonally to the longitudinal direction of the pair of blades 12 and in the up-down direction.

The hedge trimmer 100 further includes an electric circuit unit 30 housed at a front upper portion inside the housing 14. The electric circuit unit 30 is electrically connected to the power cable 20 and is configured to adjust external power supplied via the power cable 20 and supply the same to the motor 26. When the user operates the first drive switch 21 and the second drive switch 22, the electric circuit unit 30 starts supplying power to the motor 26. The electric circuit unit 30 stops supplying power to the motor 26 when operation on the first drive switch 21 and/or the second drive switch 22 is released. Therefore, the electric circuit unit 30 can switch the motor 26 on and off. The electric circuit unit 30 further can switch the main power of the hedge trimmer 100 on and off, change a rotation speed of the motor 26, drive the motor 26 in a backward rotation direction, and the like, based on an operation status of the operation button 32 which the user operates. In the present embodiment, the motor 26 is a brushless motor, thus the electric circuit unit 30 further includes an inverter circuit 30a. The inverter circuit 30a is electrically connected to the power cable 20 and also electrically connected to the motor 26. The inverter circuit 30a converts direct current from the power cable 20 to alternating current and supplies the same to the motor 26.

(Configuration of Pair of Blades 12)

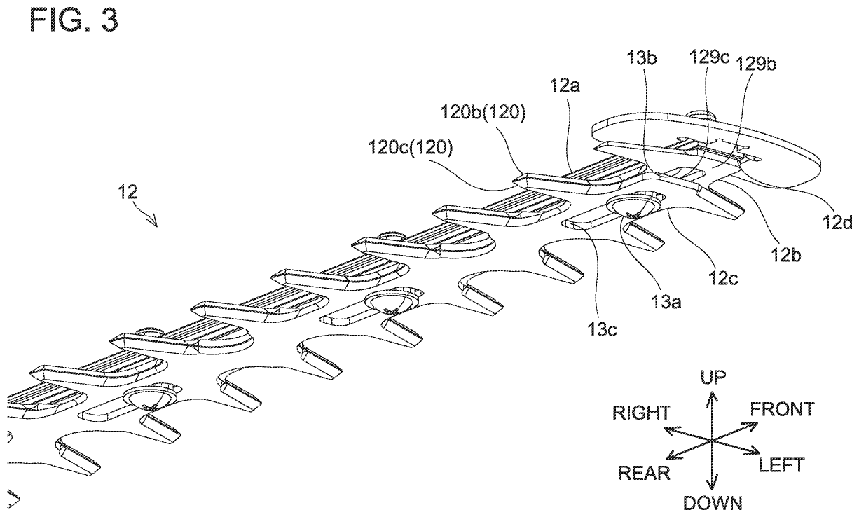

As illustrated in FIG. 3, the pair of blades 12 includes a guide bar 12a, a guide plate 12d, an upper blade 12b and a lower blade 12c. A plurality of slots 13b and a plurality of slots 13c are defined in the upper blade 12b and the lower blade 12c. The upper blade 12b and the lower blade 12c are attached to the guide bar 12a and the guide plate 12d positioned on the upper blade 12b by guide members 13a inserted into the slots 13b, 13c. A slide surface 129b is formed on the lower surface of the upper blade 12b, and a slide surface 129c is formed on the upper surface of the lower blade 12c. The upper blade 12b and the lower blade 12c can slide and reciprocate relative to each other in the front-rear direction at the slide surfaces 129b, 129c.

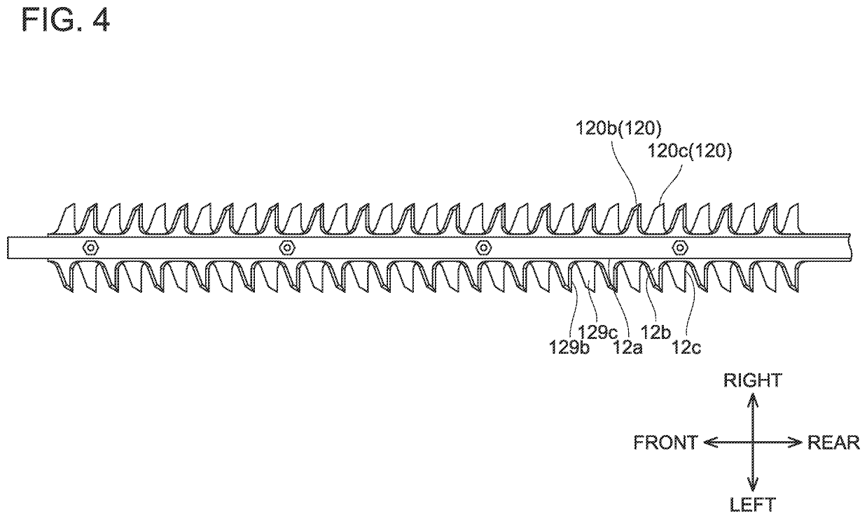

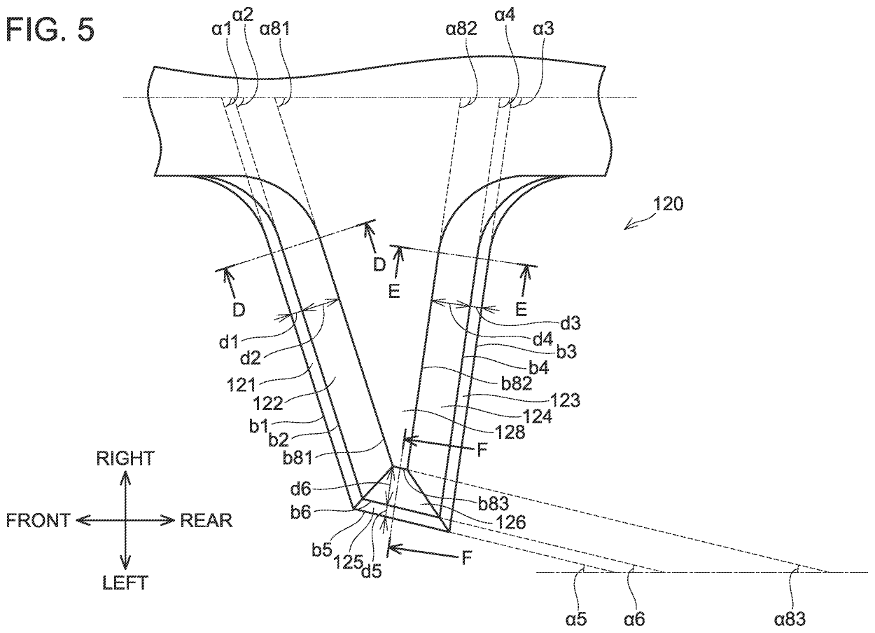

As illustrated in FIG. 4, each of the upper blade 12b and the lower blade 12c includes a plurality of edge portions 120b, 120c along the front-rear direction on the both sides in the left-right direction. The slide surfaces 129b, 129c of the upper blade 12b and the lower blade 12c extend to the plurality of edge portions 120b, 120c. The plurality of edge portions 120b, 120c are disposed at predetermined intervals in the front-rear direction. In the present embodiment, a position of each of the plurality of edge portions 120b on the left side of the upper blade 12b in the front-rear direction is offset from its corresponding one of the plurality of edge portions 120b on the right side of the upper blade 12b by half the interval. Similarly, a position of each of the plurality of edge portions 120c on the left side of the lower blade 12c in the front-rear direction is offset from its corresponding one of the plurality of edge portions 120c on the right side of the lower blade 12c by half the interval. In the present embodiment, the upper blade 12b and the lower blade 12c have the same shape. Each of the plurality of edge portions 120b has the same shape on the left side. Each of the plurality of edge portions 120b has the same shape on the left side. A shape of each of the plurality of edge portions 120b on the left side of the upper blade 12b is a mirror-image of a shape of each of the plurality of edge portions 120b on the right side of the upper blade 12b. Similarly, each of the plurality of edge portions 120c has the same shape on the left side. Each of the plurality of edge portions 120c has the same shape on the right side. A shape of each of the plurality of edge portions 120c on the left side of the lower blade 12c is a mirror-image of a shape of the each of the plurality of edge portions 120c on the right side of the lower blade 12c. In other words, each of the edge portions 120b on the left side of the upper blade 12b has the same shape as each of the edge portions 120c on the right side of the lower blade 12c. Each of the edge portions 120b on the right side of the upper blade 12b has the same shape as each of the edge portions 120c on the left side of the lower blade 12c. In the present embodiment, stainless steel is used for the upper blade 12b and the lower blade 12c, and the upper blade 12b and the lower blade 12c are formed by die forging such as heat forging or cold forging. Thus, even when the upper blade 12b and the lower blade 12c have a plurality of edge portions 120 (FIG. 5) each including a plurality of edge surfaces to be described, the blades are easily created and mass manufacturing of the blades is enabled.

(Configurations of Plurality of Edge Portions 120b, 120c)

Hereafter, the plurality of edge portions 120b, 120c included in each of the pair of blades 12 of the embodiment will be described in detail with reference to the drawings, taking one of the edge portions 120 as an example. In FIG. 5 to FIG. 8, the edge portion 120 is illustrated such that it corresponds to one of the edge portions 120b on the left side of the upper blade 12b or one of the edge portions 120c of on the right side the lower blade 12c.

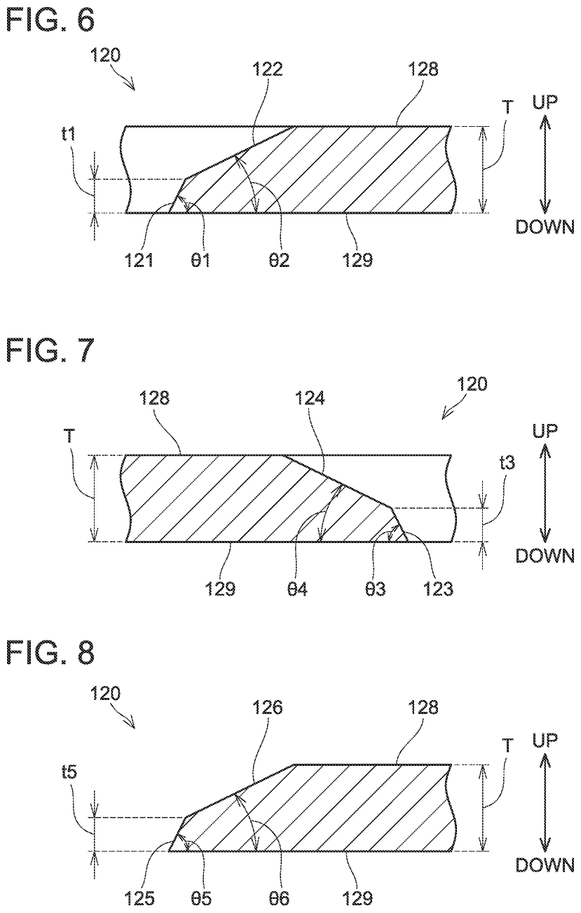

As illustrated in FIG. 5 and FIG. 6, the edge portion 120 includes a first edge surface 121 and a second edge surface 122 on its front side. As illustrated in FIG. 5, the first edge surface 121 is connected to the slide surface 129 via a first connecting line b1 inclined with respect to the front-rear direction at a tilting angle α1. The tilting angle α1 may be within a range from 70 degrees to 90 degrees, and is 70 degrees in the present embodiment. As illustrated in FIG. 6, the first edge surface 121 is disposed at a first angle θ1 with respect to the slide surface 129. The first angle θ1 may be within a range from 45 degrees to 70 degrees, and is 45 degrees in the present embodiment. As illustrated in FIG. 5, the second edge surface 122 is connected to the first edge surface 121 via a second connecting line b2 inclined with respect to the front-rear direction at a tilting angle α2. The tilting angle α2 may be within a range from 70 degrees to 90 degrees, and is 70 degrees in the present embodiment. The second edge surface 122 is connected to a top surface 128 via a top surface connecting line b81 inclined with respect to the front-rear direction at a tilting angle α81. The tilting angle α81 may be within a range from 70 degrees to 90 degrees, and is 70 degrees in the present embodiment. In the present embodiment, the top surface 128 is a surface parallel to the slide surface 129. As illustrated in FIG. 6, the second edge surface 122 is disposed at a second angle θ2 with respect to the slide surface 129. The second angle θ2 may be within a range from 20 degrees to 45 degrees, and is 30 degrees in the present embodiment. The first angle θ1 is larger than the second angle θ2. A ratio of the first angle θ1 with respect to the second angle θ2 may be within a range from 1:1 to 7:2, and is 3:2 in the present embodiment.

As illustrated in FIG. 5, the first edge surface 121 has a first width d1 in a direction orthogonal to the first connecting line b1 as viewed from above. The first width d1 is a distance between the first connecting line b1 and the second connecting line b2. The second edge surface 122 has a second width d2 in a direction orthogonal to the second connecting line b2 as viewed from above. The second width d2 is a distance between the second connecting line b2 and the top surface connecting line b81. A ratio of the first width d1 to the second width d2 may be within a range from 7:80 to 5:7, and is 1:4 in the present embodiment. The first width d1 may be within a range from 0.28 mm to 0.8 mm, and the second width d2 may be within a range from 1.12 mm to 3.2 mm. In the present embodiment, the first width d1 is 0.4 mm and the second width d2 is 1.6 mm.

As illustrated in FIG. 6, the edge portion 120 has a thickness T in the up-down direction. The thickness T of the edge portion 120 in the up-down direction may be within a range from 1.6 mm to 4.0 mm, and the thickness T of the edge portion 120 in the up-down direction is 2.0 mm in the present embodiment. The edge portion 120 is formed such that a thickness t1 of the first edge surface 121 in the up-down direction is 0.3 times or less the thickness T of the edge portion 120 in the up-down direction.

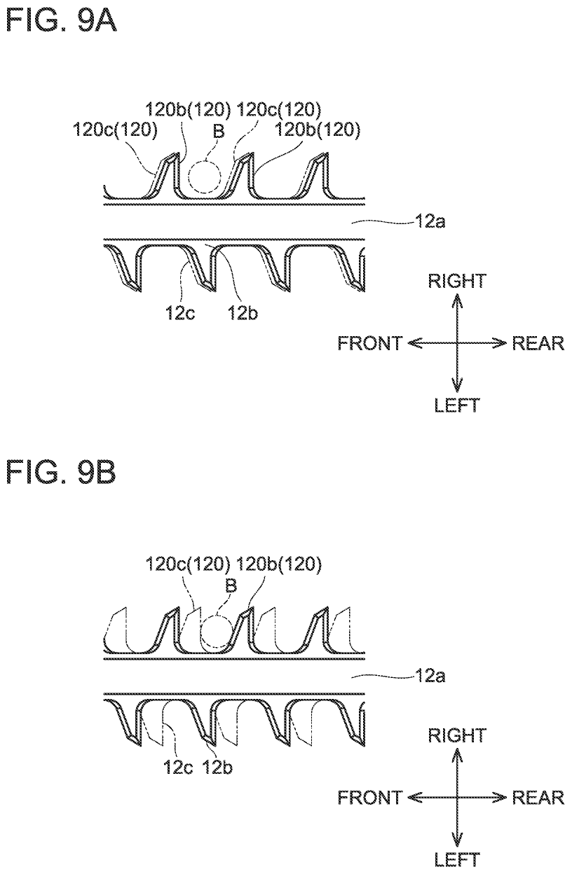

As illustrated in FIG. 5 and FIG. 7, the edge portion 120 includes a third edge surface 123 and a fourth edge surface 124 on its rear side. As illustrated in FIG. 5, the third edge surface 123 is connected to the slide surface 129 via a third connecting line b3 inclined with respect to the front-rear direction at a tilting angle α3. The tilting angle α3 may be within a range from 70 degrees to 90 degrees, and is 80 degrees in the present embodiment. As illustrated in FIG. 7, the third edge surface 123 is disposed at a third angle θ3 with respect to the slide surface 129. The third angle θ3 may be within a range from 45 degrees to 70 degrees, and is 45 degrees in the present embodiment. As illustrated in FIG. 5, the fourth edge surface 124 is connected to the third edge surface 123 via a fourth connecting line b4 inclined with respect to the front-rear direction at a tilting angle α4. The tilting angle α4 may be within a range from 70 degrees to 90 degrees, and is 80 degrees in the present embodiment. The fourth edge surface 124 is connected to a top surface 128 via a top surface connecting line b82 inclined with respect to the front-rear direction at a tilting angle α82. The tilting angle α82 may be within a range from 70 degrees to 90 degrees, and is 80 degrees in the present embodiment. As illustrated in FIG. 7, the fourth edge surface 124 is disposed at a fourth angle θ4 with respect to the slide surface 129. The fourth angle θ4 may be within a range from 20 degrees to 45 degrees, and is 30 degrees in the present embodiment. The third angle θ3 is larger than the fourth angle θ4. A ratio of the third angle θ3 to the fourth angle θ4 may be within a range from 1:1 to 7:2, and is 3:2 in the present embodiment.

As illustrated in FIG. 5, the third edge surface 123 has a third width d3 in a direction orthogonal to the third connecting line b3 as viewed from above. The third width d3 is a distance between the third connecting line b3 and the fourth connecting line b4. The fourth edge surface 124 has a fourth width d4 in a direction orthogonal to the fourth connecting line b4 as viewed from above. The fourth width d4 is a distance between the fourth connecting line b4 and the top surface connecting line b82. A ratio of the third width d3 to the fourth width d4 may be within a range from 7:80 to 5:7, and is 1:4 in the present embodiment. The third width d3 may be within a range from 0.28 mm to 0.8 mm, and the fourth width d4 may be within a range from 1.12 mm to 3.2 mm. In the present embodiment, the third width d3 is 0.4 mm and the fourth width d4 is 1.6 mm.

As illustrated in FIG. 7, the edge portion 120 is formed such that a thickness t3 of the third edge surface 123 in the up-down direction is 0.3 times or less the thickness T of the edge portion 120 in the up-down direction.

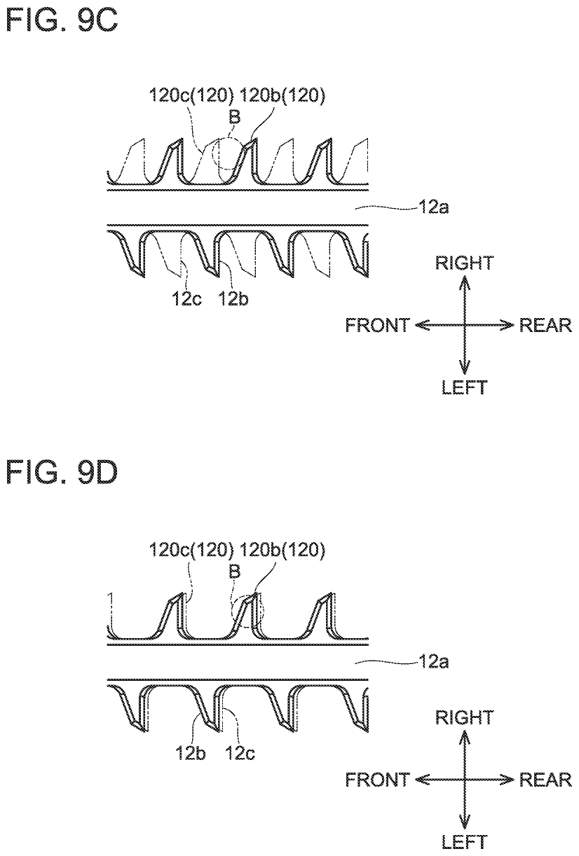

As illustrated in FIG. 5 and FIG. 8, the edge portion 120 includes a fifth edge surface 125 and a sixth edge surface 126 on its left side. As illustrated in FIG. 5, the fifth edge surface 125 is connected to the slide surface 129 via a fifth connecting line b5 inclined with respect to the front-rear direction at a tilting angle α5. The tilting angle α5 may be within a range from 0 degree to 30 degrees, and is 15 degrees in the present embodiment. As illustrated in FIG. 8, the fifth edge surface 125 is disposed at a fifth angle θ5 with respect to the slide surface 129. The fifth angle θ5 may be within a range from 45 degrees to 70 degrees, and is 45 degrees in the present embodiment. As illustrated in FIG. 5, the sixth edge surface 126 is connected to the fifth edge surface 125 via a sixth connecting line b6 inclined with respect to the front-rear direction at a tilting angle α6. The tilting angle α6 may be within a range from 0 degree to 30 degrees, and is 15 degrees in the present embodiment. The sixth edge surface 126 is connected to the top surface 128 via a top surface connecting line b83 inclined with respect to the front-rear direction at a tilting angle α83. The tilting angle α83 may be within a range from 0 degree to 30 degrees, and is 15 degrees in the present embodiment. As illustrated in FIG. 8, the sixth edge surface 126 is disposed at a sixth angle θ6 with respect to the slide surface 129. The sixth angle θ6 may be within a range from 20 degrees to 45 degrees, and is 30 degrees in the present embodiment. The fifth angle θ5 is larger than a sixth angle θ6. A ratio of the fifth angle θ5 to the sixth angle θ6 may be within a range from 1:1 to 7:2, and is 3:2 in the present embodiment. The fifth edge surface 125 is connected to the first edge surface 121 at its front side and connected to the third edge surface 123 at its rear side.

As illustrated in FIG. 5, the fifth edge surface 125 has a fifth width d5 in a direction orthogonal to the fifth connecting line b5 as viewed from above. The fifth width d5 is a distance between the fifth connecting line b5 and the sixth connecting line b6. The sixth edge surface 126 has a sixth width d6 in a direction orthogonal to the sixth connecting line b6 as viewed from above. The sixth width d6 is a distance between the sixth connecting line b6 and the top surface connecting line b83. A ratio of the fifth width d5 to the sixth width d6 may be within a range from 7:80 to 5:7, and is 1:4 in the present embodiment. The fifth width d5 may be within a range from 0.28 mm to 0.8 mm, and the sixth width d6 may be within a range from 1.12 mm to 3.2 mm. In the present embodiment, the fifth width d5 is 0.4 mm and the sixth width d6 is 1.6 mm.

As illustrated in FIG. 8, the edge portion 120 is formed such that a thickness t5 of the fifth edge surface 125 in the up-down direction is 0.3 times or less the thickness T of the edge portion 120 in the up-down direction.

(Operation of Pair of Blades 12)

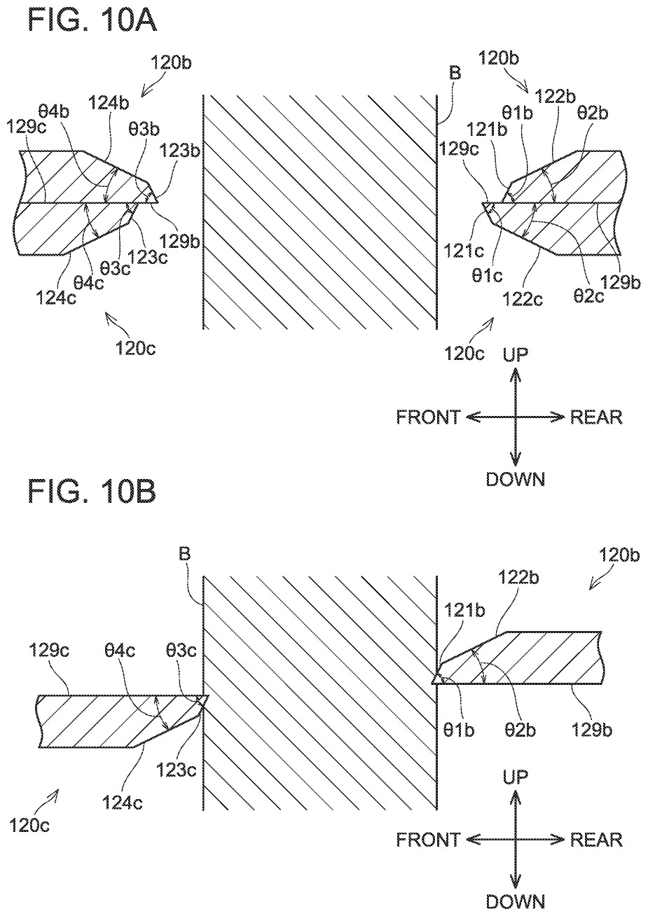

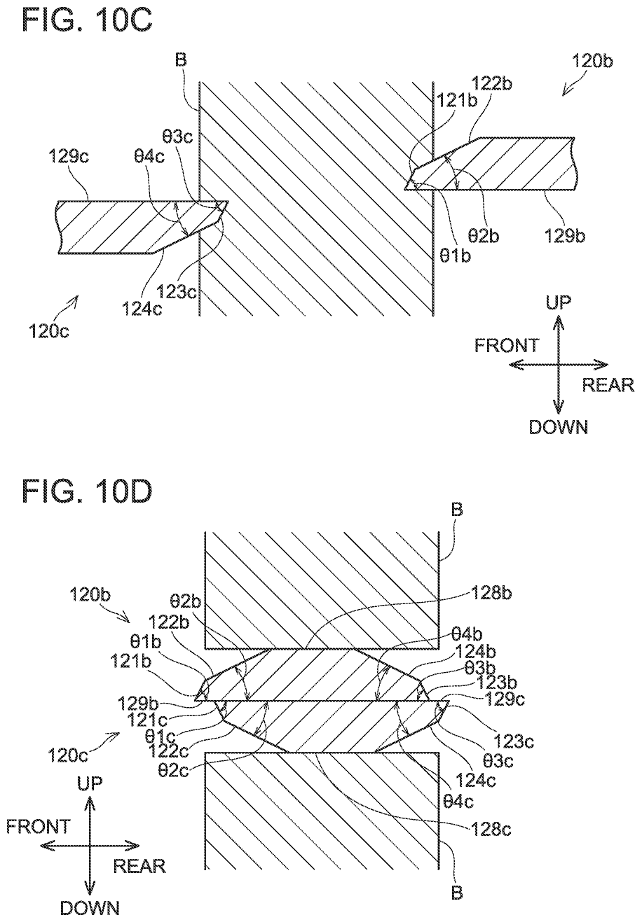

Hereafter, operation when the pair of blades 12 is actuated will be described. In FIG. 9A to FIG. 9D, the upper blade 12b is illustrated in solid lines and the lower blade 12c is illustrated in two-dot chain lines to distinguish the upper blade 12b and the lower blade 12c. As described above, in the present embodiment, when the upper blade 12b and the lower blade 12c are actuated by the motor 26, each blade reciprocates in the front-rear direction relative to the housing 14, however, in FIG. 9A to FIG. 9D, reciprocation of the lower blade 12c relative to the upper blade 12b is illustrated with respect to the upper blade 12b. Each of FIG. 10A to FIG. 10D is equivalent to a figure obtained by viewing its corresponding example of FIG. 9A to FIG. 9D from the left side of an object B to be cut.

As illustrated in FIG. 9A to FIG. 9D, in the present embodiment, a distance by which the lower blade 12c moves in the front-rear direction relative to the upper blade 12b when the pair of blades 12 reciprocates is equal to an interval between the edge portions 120b, 120c. When the pair of blades 12 reciprocates, the edge portion 120c alternately repeats operation to move in the rearward direction and overlap with one edge portion 120b and operation to move in the forward direction and overlap with another edge portion 120b. As illustrated in FIG. 9D and FIG. 10D, the edge portions 120b, 120c slide and overlap at the slide surfaces 129b, 129c upon the operation to overlap with each other. When the object B to be cut is positioned between the edge portion 120b and the edge portion 120c in the reciprocating direction of the edge portion 120b and the edge portion 120c (front-rear direction), the object B is cut by the overlapping operation of the edge portions 120b, 120c. Hereafter, the operation to cut the object B by the edge portions 120b, 120c will be described in detail.

(Cutting Operation of Edge Portions 120b, 120c)

As illustrated in FIG. 9A and FIG. 10A, when the lower blade 12c moves in the rearward direction relative to the upper blade 12b, the first edge surface 121b of the edge portion 120b and the third edge surface 123c of the edge portion 120c enter into the object B to be cut. As illustrated in FIG. 9B and FIG. 10B, very high load is applied on the first edge surface 121b and the third edge surface 123c when the edge portions 120b, 120c enter the object B. However, since the first angle θ1b between the first edge surface 121b and the slide surface 129b is 45 degrees, the edge portion 120b exhibits great durability against the load applied on the first edge surface 121b. Since the first width d1b of the first edge surface 121b is 0.4 mm, the first edge surface 121b will not cause a substantial decrease in sharpness of the edge portion 120b. Similarly, since the third angle θ3c between the third edge surface 123c and the slide surface 129c is 45 degrees, the edge portion 120c exhibits great durability against the load applied on the third edge surface 123c. Since the third width d3c of the third edge surface 123c is 0.4 mm, the third edge surface 123c will not cause a substantial decrease in sharpness of the edge portion 120c.

As illustrated in FIG. 9C and FIG. 10C, after FIG. 9B and FIG. 10B, the edge portions 120b, 120c which have entered into the object B to be cut press and expand the cut surface in the object B using the second edge surface 122b and the fourth edge surface 124c to cut the object B. Overall sharpness of the edge portions 120b, 120c depends on resistance which the second edge surface 122b and the fourth edge surface 124c receive in the cutting direction when they press and expand the object B. Here, since the second angle θ2b between the second edge surface 122b and the slide surface 129b is 30 degrees, resistance received in the cutting direction is reduced, and the edge portion 120b as a whole exhibits great sharpness. Since the second width d2b of the second edge surface 122b is 1.6 mm, the second edge surface 122b will not cause a substantial decrease in sharpness of the edge portion 120b. Similarly, since the fourth angle θ4c between the fourth edge surface 124 and the slide surface 129c is 30 degrees, resistance received in the cutting direction is reduced, and the edge portion 120c as a whole exhibits great sharpness. Since the fourth width d4c of the fourth edge surface 124c is 1.6 mm, the fourth edge surface 124c will not cause a substantial decrease in durability of the edge portion 120c.

In the present embodiment, the shape of the lower blade 12c is the same as the shape of the upper blade 12b, and the shape of each of the edge portions 120b on the right side of the upper blade 12b is a mirror image of the shape of each of the edge portions 120c on the right side of the lower blade 12c. Therefore, the operation for the edge portions 120b, 120c to cut the object B to be cut when the lower blade 12c moves in the forward direction relative to the upper blade 12b corresponds to the operation when the upper blade 12b moves in the forward direction relative to the lower blade 12c in the example illustrated in FIG. 9A to FIG. 9D and FIG. 10A to FIG. 10D. Accordingly, the above explanation about the case in which the lower blade 12c moves in the rearward direction relative to the upper blade 12b similarly applies to the case in which the lower blade 12c moves in the frontward direction relative to the upper blade 12b.

Here, when the tilting angle α1 at which the first connecting line b1 of the edge portion 120 is inclined relative to the front-rear direction or the tilting angle α3 at which the third connecting line b3 is inclined relative to the front-rear direction is too large, the object B to be cut adversely is displaced to the side of the pair of blades 12 when the edge portions 120 are entering into the object B, by which the object B may not be cut. In the pair of blades 12 of the present embodiment, since the tilting angle α1 at which the first connecting line b1 of the edge portion 120 is inclined relative to the front-rear direction is 80 degrees and the titling angle α3 at which the third connecting line b3 is inclined relative to the front-rear direction is 80 degrees, the object B can be cut without the object B being displaced to the side of the pair of blades 12. Further, since the titling angle α5 at which the fifth connecting line b5 of the edge portion 120 is inclined relative to the front-rear direction is 15 degrees, the object B on the side of the pair of blades 12 is easily guided to a position between the edge portion 120b and the edge portion 120c.

(Variant)

In the above embodiment, the hedge trimmer 100 was described as an example of the working machine including the pair of blades 12. Unlike this, the working machine may be a working machine other than the hedge trimmer 100. For example, the working machine may for example be a pole hedge or a ground trimmer.

In the above embodiment, the configuration including the motor 26 as an example of the prime mover was described. Unlike this, the prime mover may be a prime mover other than the motor 26. For example, the prime mover may be an engine.

In the above embodiment, the configuration in which the prime mover (motor 26) is a brushless motor was described. Unlike this, the prime mover (motor 26) may be a motor other than a brushless motor. For example, the prime mover (motor 26) may be a brushed motor.

In the above embodiment, the configuration in which the working machine (hedge trimmer 100) includes the power cable 20 and supplies external power to the hedge trimmer 100 through the power cable 20 was described. Unlike this, the working machine (hedge trimmer 100) may include a battery pack (not illustrated) configured to be attached to and detached from the rear handle 18 and may supply power to the working machine (hedge trimmer 100) from the battery pack.

In the above embodiment, the configuration in which each of the pair of blades 12 is configured to reciprocate relative to the housing 14 was described. Unlike this, only one of the pair of blades 12 may be configured to reciprocate relative to the housing 14 and the other of the pair of blades 12 may be fixed to the housing 14.

In the above example, the configuration in which each of the upper blade 12b and the lower blade 12c includes the plurality of edge portions 120b, 120c on the both side in the left-right direction was described. Unlike this, each of the upper blade 12b and the lower blade 12c may include the plurality of edge portions 120b, 120c only on the left side. Alternatively, each of the upper blade 12b and the lower blade 12c may include the plurality of edge portions 120b, 120c only on the right side.

In the above embodiment, the configuration in which stainless steel is used for the upper blade 12b and the lower blade 12c was described. Unlike this, for example, steel, copper, silver, gold, aluminum, titan or nickel may be used for the upper blade 12b and the lower blade 12c, or an alloy of the aforementioned materials may be used for the upper blade 12b and the lower blade 12c.

In the above embodiment, the tilting angle α1 of the first connecting line b1, the tilting angle α2 of the second connecting line b2, the tilting angle α3 of the third connecting line b3, the tilting angle α4 of the fourth connecting line b4, the tilting angle α5 of the fifth connecting line b5, the tilting angle α6 of the sixth connecting line b6, the tilting angle α81 of the top-surface connecting line b81, the tilting angle α82 of the top-surface connecting line b82, and the tilting angle α83 of the top-surface connecting line b83 of each of the edge portions 120 of the pair of blades 12 may be suitably changed in the process of forming the pair of blades 12.

In the above embodiments, the first angle θ1, the second angle θ2, the third angle θ3, the fourth angle θ4, the fifth angle θ5, the sixth angle θ6, the first width d1, the second width d2, the third width d3, the fourth width d4, the fifth width d5 and the sixth width d6 of each of the edge portions 120 of the pair of blades 12 may be suitably changed in the process of forming the pair of blades 12. Since in reality required sharpness and required durability vary in accordance with the type of the object B to be cut, the pair of blades 12 of the present embodiment may be formed in accordance with a type of the object B. In particular, when the object B to be cut is a thick branch and the pair of blades 12 is actuated at a high voltage and high torque, durability is more prioritized than sharpness as compared to the usual case, however, sufficient durability can be realized by setting the first angle θ1, the third angle θ3 and the fifth angle θ5 of the edge portion 120 to relatively large angles within the respective angle ranges.

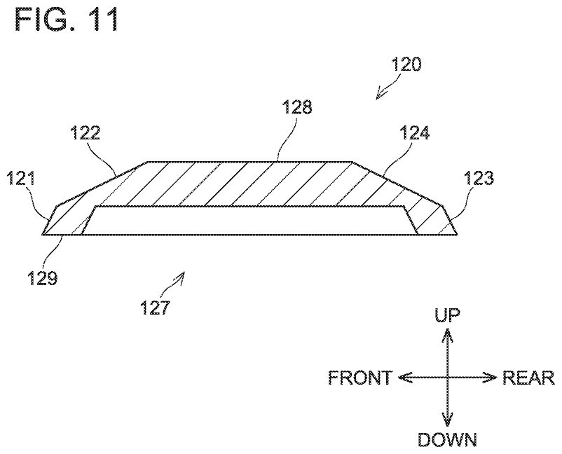

In the above embodiment, the configuration in which the lower portion of each of the edge portions 120 is flat was described. Unlike this, as illustrated in FIG. 11, a cavity 127 may be defined in the lower portion of each of the edge portions 120. The cavity 127 may be defined so that an area of the slide surface 129 is decreased without a substantial decrease in durability of the edge portion 120 as compared to the case in which the lower portion of the edge portion 120 is flat. In this case, slide resistance generated in one edge portion 120 sliding with respect to another edge portion 120 is decreased, by which energy loss due to the slide resistance in the working machine (the hedge trimmer 100) can be decreased. Further, a weight of the pair of blades 12 per se is reduced, by which maneuverability of the working machine (the hedge trimmer 100) is increased and energy required to actuate the pair of blades 12 cand be reduced.

(Corresponding Relationships)

In one or more embodiments, the hedge trimmer 100 (an example of the working machine) comprises: the pair of blades 12; and the motor 26 (an example of the prime mover) configured to reciprocate the pair of blades 12 relative to each other. Each of the pair of blades 12 (the upper blade 12b and the lower blade 12c) comprises the plurality of edge portions 120 (120b, 120c) disposed along the reciprocating direction (the front-rear direction). Each of the plurality of edge portions 120 (120b, 120c) of one of the pair of blades 12 (the upper blade 12b, the lower blade 12c) comprises: the slide surface 129 (129b, 129c) configured to slide with respect to the plurality of edge portions 120 (120c, 120b) of the other of the pair of blades 12 (the lower blade 12c, the upper blade 12b) as the pair of blades 12 reciprocates relative to each other; the first edge surface 121 (121b, 121c) connected to the slide surface 129 (129b, 129c) via the first connecting line b1 and disposed at the first angle θ1 with respect to the slide surface 129 (129b, 129c), the first connecting line b1 being inclined with respect to the reciprocating direction (front-rear direction); and the second edge surface 122 (122b, 122c) connected to the first edge surface 121 (121b, 121c) via the second connecting line b2 and disposed at the second angle θ2 with respect to the slide surface 129 (129b, 129c), via the second connecting line b2 being inclined with respect to the reciprocating direction (the front-rear direction). The first angle θ1 is greater than the second angle θ2.

In one or more embodiments, the pair of blades 12 is the pair of blades 12 configured to be attached to the hedge trimmer 100 comprising the motor 26 and reciprocated relative to each other by the motor 26. Each of the pair of blades 12 (the upper blade 12b and the lower blade 12c) comprises the plurality of edge portions 120 (120b, 120c) disposed along the reciprocating direction (the front-rear direction). Each of the plurality of edge portions 120 (120b, 120c) of one of the pair of blades 12 (the upper blade 12b, the lower blade 12c) comprises: the slide surface 129 (129b, 129c) configured to slide with respect to the plurality of edge portions 120 (120c, 120b) of the other of the pair of blades 12 (the lower blade 12c, the upper blade 12b) as the pair of blades 12 reciprocates relative to each other; the first edge surface 121 (121b, 121c) connected to the slide surface 129 (129b, 129c) via the first connecting line b1 and disposed at the first angle θ1 with respect to the slide surface 129 (129b, 129c), the first connecting line b1 being inclined with respect to the reciprocating direction (the front-rear direction); and the second edge surface 122 (122b, 122c) connected to the first edge surface 121 (121b, 121c) via the second connecting line b2 and disposed at the second angle θ2 with respect to the slide surface 129 (129b, 129c), the second connecting line b2 being inclined with respect to the reciprocating direction (the front-rear direction). The first angle θ1 is greater than the second angle θ2.

According to the above configuration, each of the edge portions 120 (120b, 120c) of the pair of blades 12 has two edge surfaces. The first edge surface 121 (121b, 121c) positioned at the cutting edge of each of the edge portions 120 (120b, 120c) of the pair of blades 12 is disposed at the first angle θ1 with respect to the slide surface 129 (129b, 129c), and the second edge surface 122 (122b, 122c) positioned away from the cutting edge is disposed at the second angle θ2, which is smaller than the first angle θ1, to the slide surface 129 (129b, 129c). Therefore, the sharpness is increased by reducing resistance received in the cutting direction when the edge portions 120 tear and open the object B to be cut, and durability against the load applied upon cutting is also increased. In other words, according to the above configuration, both sharpness and durability can be achieved in the edge portions 120 (120b, 120c) of the pair of blades 12.

In one or more embodiments, the first edge surface 121 (121b, 121c) has the first width d1 in the direction orthogonal to the first connecting line b1, as viewed from above (an example of the direction orthogonal to the slide surface), and the second edge surface 122 (122b, 122c) has the second width d2 in the direction orthogonal to the second connecting line b1, as viewed from above. The ratio of the first width d1 to the second width d2 is 1:4.

If the ratio of the first width d1 of the first edge surface 121 (121b, 121c) entering into the object B to be cut to the second width d2 of the second edge surface 122 (122b, 122c) tearing and opening the object B is too small, the sharpness upon cutting is adversely decreased. Contrary to this, if the ratio of the first width d1 of the first edge surface 121 (121b, 121c) to the second width d2 of the second edge surface 122 (122b, 122c) is too large, the durability against the load applied upon cutting is adversely decreased. According to the above configuration, both the sharpness and durability can more suitably be achieved in the edge portions 120 (120b, 120c) of the pair of blades 12.

In one or more embodiments, the first width d1 is within a range from 0.28 mm to 0.8 mm.

When the first width d1 of the first edge surface 121 (121b, 121c) is too small, it is difficult to achieve an effect of improving the durability. On the other hand, when the first width d1 of the first edge surface 121 (121b, 121c) is too large, this may cause a substantial decrease in the sharpness. According to the above configuration, in the edge portions 120 (120b, 120c) of the pair of blades 12, the effect of improving the durability can sufficiently be obtained without causing a substantial decrease in the sharpness.

In one or more embodiments, the second width d2 is within a range from 1.12 mm to 3.2 mm.

When the second width d2 of the second edge surface 122 (122b, 122c) is too small, it is difficult to achieve an effect of improving the sharpness. On the other hand, when the second width d2 of the second edge surface 122 (122b, 122c) is too large, this may cause a substantial decrease in the durability. According to the above configuration, in the edge portions 120 (120b, 120c) of the pair of blades 12, the effect of improving the sharpness can sufficiently be obtained without causing a substantial decrease in the durability.

In one or more embodiments, the ratio of the first angle θ1 to the second angle θ2 is 3:2.

When the ratio of the first angle θ1 between the first edge surface 121 (121b, 121c) and the slide surface 129 (129b, 129c) to the second angle θ2 between the second edge surface 122 (122b, 122c) and the slide surface 129 (129b, 129c) is too small, sharpness upon cutting is adversely decreased. On the other hand, when the ratio of the first angle θ1 to the second angle θ2 is too large, durability against the load applied upon cutting is adversely decreased. According to the above configuration, both the sharpness and durability can more suitably be achieved in the edge portions 120 (120b, 120c) of the pair of blades 12.

In one or more embodiments, the first angle θ1 is within a range from 45 degrees to 70 degrees.

When the first angle θ1 is too small, it is difficult to achieve an effect of improving durability. On the other hand, when the first angle θ1 is too large, this may cause a substantial decrease in sharpness. According to the above configuration, in the edge portions 120 (120b, 120c) of the pair of blades 12, the effect of improving the durability can sufficiently be obtained without causing a substantial decrease in the sharpness.

In one or more embodiments, the second angle θ2 is within a range from 20 degrees to 45 degrees.

When the second angle θ2 is too small, this may cause a substantial decrease in durability. On the other hand, when the second angle θ2 is too large, it is difficult to achieve an effect of improving sharpness. According to the above configuration, in the edge portions 120 (120b, 120c) of the pair of blades 12, the effect of improving the sharpness can sufficiently be obtained without causing a substantial decrease in the durability.

In one or more embodiments, the first edge surface 121 (121b, 121c) and the second edge surface 122 (122b, 122c) are formed by die forging.

When the first edge surface 121 (121b, 121c) and the second edge surface 122 (122b, 122c) are formed on each of the edge portions 120 (120b, 120c), it is contemplated to perform polishing. In that case, however, the polishing needs to be separately performed on each of the plurality of edge portions 120 (120b, 120c), which makes mass production of the pair of blades 12 (upper blade 12b, lower blade 12) (examples of the blades) difficult. According to the above configuration, the first edge surface 121 (121b, 121c) and the second edge surface 122 (122b, 122c) can be formed in one processing, thus mass production of the pair of blades 12 (upper blade 12b, lower blade 12c) is facilitated.

What is claimed is:

1. A working machine comprising:
a pair of blades; and
a prime mover configured to reciprocate the pair of blades relative to each other,
wherein
each of the pair of blades comprises a plurality of edge portions disposed along a reciprocating direction,
each of the plurality of edge portions of one of the pair of blades comprises:
a slide surface configured to slide with respect to the plurality of edge portions of the other of the pair of blades as the pair of blades reciprocates relative to each other;
a first edge surface connected to the slide surface via a first connecting line and disposed at a first angle with respect to the slide surface, the first connecting line being inclined with respect to the reciprocating direction; and
a second edge surface connected to the first edge surface via a second connecting line and disposed at a second angle with respect to the slide surface, the second connecting line being inclined with respect to the reciprocating direction, and
the first angle is greater than the second angle.

2. The working machine according to claim 1, wherein
the first edge surface has a first width in a direction orthogonal to the first connecting line as viewed in a direction orthogonal to the slide surface,
the second edge surface has a second width in a direction orthogonal to the second connecting line as viewed in the direction orthogonal to the slide surface, and
a ratio of the first width to the second width is 1:4.

3. The working machine according to claim 2, wherein the first width is within a range from 0.28 mm to 0.8 mm.

4. The working machine according to claim 2, wherein the second width is within a range from 1.12 mm to 3.2 mm.

5. The working machine according to claim 1, wherein a ratio of the first angle to the second angle is 3:2.

6. The working machine according to claim 1, wherein the first angle is within a range from 45 degrees to 70 degrees.

7. The working machine according to claim 1, wherein the second angle is within a range from 20 degrees to 45 degrees.

8. The working machine according to claim 1, wherein the first edge surface and the second edge surface are formed by die forging.

9. A pair of blades configured to be attached to a working machine that comprises a prime mover and configured to be reciprocated relative to each other by the prime mover, wherein
each of the pair of blades comprises a plurality of edge portions disposed along a reciprocating direction,
each of the plurality of edge portions of one of the pair of blades comprises:
a slide surface configured to slide with respect to the plurality of edge portions of the other of the pair of blades as the pair of blades reciprocates relative to each other;
a first edge surface connected to the slide surface via a first connecting line and disposed at a first angle with respect to the slide surface, the first connecting line being inclined with respect to the reciprocating direction; and
a second edge surface connected to the first edge surface via a second connecting line and disposed at a second angle with respect to the slide surface, the second connecting line being inclined with respect to the reciprocating direction, and
the first angle is greater than the second angle.

10. The working machine according to claim 3, wherein
the second width is within a range from 1.12 mm to 3.2 mm,
a ratio of the first angle to the second angle is 3:2,
the first angle is within a range from 45 degrees to 70 degrees,
the second angle is within a range from 20 degrees to 45 degrees, and
the first edge surface and the second edge surface are formed by die forging.

11. The pair of blades according to claim 9, wherein
the first edge surface has a first width in a direction orthogonal to the first connecting line as viewed in a direction orthogonal to the slide surface,
the second edge surface has a second width in a direction orthogonal to the second connecting line as viewed in the direction orthogonal to the slide surface,
a ratio of the first width to the second width is 1:4,
the first width is within a range from 0.28 mm to 0.8 mm,
the second width is within a range from 1.12 mm to 3.2 mm,
a ratio of the first angle to the second angle is 3:2,
the first angle is within a range from 45 degrees to 70 degrees,
the second angle is within a range from 20 degrees to 45 degrees, and
the first edge surface and the second edge surface are formed by die forging.
